(19) United States
(12) Patent Application Publication
(10) Pub. No.: US 2015/0211856 A1
(43) Pub. Date: Jul. 30, 2015

(54) APPARATUS FOR DRIVING GYRO SENSOR AND CONTROL METHOD THEREOF

(71) Applicant: SAMSUNG ELECTRO-MECHANICS CO., LTD., Gyeonggi-Do (KR)

(72) Inventors: Kyung Rin KIM, Gyeonggi-Do (KR); Byoung Won HWANG, Gyeonggi-Do (KR); Chang Hyun KIM, Gyeonggi-Do (KR)

(73) Assignee: SAMSUNG ELECTRO-MECHANICS CO., LTD., Gyeonggi-Do (KR)

(21) Appl. No.: 14/304,704

(22) Filed: Jun. 13, 2014

(30) Foreign Application Priority Data
Jan. 27, 2014 (KR) 10-2014-0009775

(51) Int. Cl. G01C 19/5776

(52) U.S. Cl. CPC G01C 19/5776

(57) ABSTRACT

Embodiments of the invention provide a driving circuit of a gyro sensor and a method for controlling a driving circuit of a gyro sensor. The driving circuit includes an analog circuit configured to receive one or more driving displacement signals and one or more gyro signals related to one or more sensing axes from the gyro sensor, detect one or more direct current (DC) gyro signal values through a demodulation process using a clock signal generated by using the one or more driving displacement signals and the one or more gyro signals, and receive temperature data from a temperature sensor. The driving circuit further includes a signal converter configured to convert the one or more DC gyro signals and the temperature data into one or more digital signals, and a digital circuit. The digital circuit is configured to receive the one or more DC gyro signal values and the temperature data from the signal converter, and compare an output signal value from the analog circuit based on only a pre-set reference voltage with a pre-set reference value through a predetermined control signal according to a result of a comparison between a temperature variation calculated based on the temperature data with a pre-set reference variation, to control a determination of whether an offset has been generated with respect to the output signal value and performing a correction calculation on the offset or performing a termination.

### CROSS REFERENCE TO RELATED APPLICATION

This application claims the benefit of and priority under 35 U.S.C. §119 to Korean Patent Application No. KR 10-2014-0009775, entitled “APPARATUS FOR DRIVING GYRO SENSOR AND CONTROLLING METHOD THEREOF,” filed on Jan. 27, 2014, which is hereby incorporated by reference in its entirety into this application.

### BACKGROUND

1. Field of the Invention

The present invention relates to an apparatus for driving a gyro sensor and a control method thereof.

2. Description of the Related Art

Recently developed mobile devices are generally equipped with an inertial sensor module (e.g., an accelerometer, a gyro sensor, or a geomagnetic sensor) using an inertial input applied from the outside and released, and among the various inertial sensor modules, a gyro sensor detects an amount of applied rotary power of an object to measure a corresponding angular velocity. An angular velocity may be obtained by Coriolis force “F=2 mΩV”, wherein m is a mass of a sensor Mass, Ω is an angular velocity desired to be measured, and V is a movement speed of the sensor Mass.

FIG. 1 illustrates a conventional angular velocity detection principle of a gyro sensor, in which when a mass of a sensor resonates in an X direction and rotary power is applied in a Z direction, Coriolis force generates in a Y direction to convert a corresponding signal into an electrical signal, and the converted signal may be processed by a control circuit of a gyro sensor to detect inertial force with respect to an angular velocity.

A conventional gyro sensor generally includes a structure and a driving circuit for processing a gyro signal output from the structure and controlling the structure. Each of the structure and the driving circuit is packaged into a module to perform the foregoing function. The driving circuit has characteristic conditions for a normal operation in an operating voltage, current consumption, drift, offset, temperature characteristics, and the like. The temperature characteristics are characteristics for the control circuit to perform a normal operation, and the driving circuit is required to perform normal operation within a range from −40˜+85° C.

However, an offset with respect to an output signal of the driving circuit may be generated according to temperature characteristics of each element constituting the driving circuit and a temperature change that may generated by a combination of the elements, and in order to correct the offset, conventionally, representative values with respect to offset characteristics of the output signal according to a temperature change are extracted from respective temperatures and compensated. However, when a deviation with actual data occurs, an error with respect to a temperature compensation method occurs by the corresponding deviation.

### SUMMARY

Accordingly, embodiments of the invention have been made in an effort to provide a driving circuit of a gyro sensor capable of performing offset correction on an output signal according to a change in an operating temperature with respect to the driving circuit in real time through an offset corrector for offset correction that may be generated due to a change in an ambient temperature, and a control method thereof.

According to an embodiments of the invention, there is provided a driving circuit of a gyro sensor and a method for controlling a driving circuit of a gyro sensor. The driving circuit includes an analog circuit configured to receive one or more driving displacement signals and one or more gyro signals related to one or more sensing axes from the gyro sensor, detect one or more direct current (DC) gyro signal values through a demodulation process using a clock signal generated by using the one or more driving displacement signals and the one or more gyro signals, and receive temperature data from a temperature sensor. The driving circuit further includes a signal converter configured to convert the one or more DC gyro signals and the temperature data into one or more digital signals, and a digital circuit. The digital circuit is configured to receive the one or more DC gyro signal values and the temperature data from the signal converter, and compare an output signal value from the analog circuit based on only a pre-set reference voltage with a pre-set reference value through a predetermined control signal according to a result of a comparison between a temperature variation calculated based on the temperature data with a pre-set reference variation, to control a determination of whether an offset has been generated with respect to the output signal value and performing a correction calculation on the offset or performing a termination.

According to an embodiment, when the temperature variation is greater than the pre-set reference variation, the digital circuit is further configured to interrupt inputting of the one or more driving displacement signals and the one or more gyro signals, and transmit an enable signal for applying only the pre-set reference voltage to the analog circuit, to the analog circuit. The digital circuit is further configured to compare the output signal value from the analog circuit based on the pre-set reference voltage with the pre-set reference value to determine generation of the offset with respect to the output signal value and perform calculation to correct the offset, and when the calculation of the offset correction is terminated, the digital circuit is further conligured to transmit a disable signal for inputting the one or more driving displacement signals and the one or more gyro signals, to the analog circuit.

According to an embodiment, the analog circuit includes an analog signal processor configured to receive the one or more driving displacement signals and the one or more gyro signals, detect the one or more DC gyro signal values through a demodulation process using a clock signal generated by using the one or more driving displacement signals and the one or more gyro signals from the gyro sensor, and apply the pre-set reference voltage in the place of the one or more driving displacement signals and the one or more gyro signals, when the enable signal is received. The analog circuit further includes a temperature sensor signal processor configured to receive the temperature data from the temperature sensor, and an analog multiplexer configured to sequentially transmit the one or more gyro signal values and the temperature data to the signal converter.

According to an embodiment, the analog signal processor includes a charge amplifier configured to convert the one or more driving displacement signals and the one or more gyro signals output from the gyro sensor into voltage signals, amplify the voltage signals, and output the same. The analog signal processor further includes a phase shifter configured to shift a phase of a first driving displacement signal among the one or more driving displacement signals by 90°, a clock generator configured to generate the clock signal through a comparator by using a signal output from the phase shifter and a pre-set reference voltage, and a demodulator configured to perform a demodulation process of mixing the one or more gyro signals and the clock signal. The analog signal processor further includes a filter configured to cancel noise of a high frequency component from a signal input from the demodulator and output the one or more DC gyro signal values, a signal driver configured to generate a pulse wave driving signal by using the clock signal, and apply the driving signal to the gyro sensor, and a charge amplifying controller configured to interrupt the one or more driving displacement signals and the one or more gyro signals input to the charge amplifier through the enable signal transmitted from the digital circuit and apply the pre-set reference voltage to the charge amplifier, when the temperature variation is greater than the pre-set reference variation.

According to an embodiment, the digital circuit further includes a data transmitter configured to sequentially receive the one or more gyro signal values regarding each sensing axis of the gyro sensor and the temperature data from the signal converter. The digital circuit further includes an offset corrector configured to compare an output signal value from the analog circuit based on only a pre-set reference voltage with a pre-set reference value through a predetermined control signal according to a result of a comparison between the temperature variation calculated based on the temperature data with the pre-set reference variation, to control determining whether the offset has been generated with respect to the output signal value and performing correction calculation on the offset or performing termination. Further, the digital circuit includes a data corrector configured to perform correction on the one or more gyro signal values by using the control value input from the offset corrector.

According to an embodiment, the digital circuit further includes a digital filter configured to cancel noise of the one or more gyro signal values and the temperature data output from the data transmitter, and an analog interface configured to transmit the control signal output from the offset corrector into the charge amplifying controller.

According to an embodiment, the offset corrector includes an offset correcting control circuit configured to compare the temperature variation calculated based on the temperature data with the pre-set reference variation, transmit the enable signal to the charge amplifying controller according to generation of the offset with respect to the output signal value, when the temperature variation is greater than the pre-set reference variation, and transmit the disable signal to the charge amplifier, when the calculation for the offset correction is terminated. The offset corrector further includes an offset corrector configured to compare the output signal value from the analog circuit based on a reference signal with the pre-set reference value, and determine whether the offset has been generated with respect to the one or more gyro signal values and calculate a control value for correcting the offset.

According to an embodiment, until before the disable signal is transmitted after the enable signal is transmitted to the charge amplifying controller, the offset correcting control circuit is further configured to control maintaining and outputting the one or more gyro signal values prior to input of the output signal value of the analog circuit based on the pre-set reference voltage from the data transmitter.

According to an embodiment, the offset correcting control circuit includes a temperature change checking circuit configured to compare the temperature variation calculated based on the temperature data with the pre-set reference variation, transmit the enable signal to the charge amplifying controller according to the generation of the offset with respect to the output signal value, when the temperature variation is greater than the pre-set reference variation, and transmit the disable signal to the charge amplifier, when the calculation for correcting the offset is terminated.

According to an embodiment, the offset correcting control circuit further includes a data transmitting control circuit configured to receive the enable signal applied from the temperature change checking circuit, when the temperature variation is greater than the pre-set reference variation, and control maintaining and outputting the one or more gyro signal values prior to the input of the output signal value of the analog circuit based on the pre-set reference voltage from the data transmitter until before the disable signal is transmitted after the enable signal is transmitted to the charge amplifying controller.

According to an embodiment, the offset correcting circuit includes an offset detecting circuit configured to receive the enable signal from the temperature change checking circuit, when the temperature variation calculated based on the temperature data is greater than the pre-set reference variation, and determine whether the offset has been generated with respect to the output signal value by comparing an output signal value from the analog circuit based on the pre-set reference voltage with the pre-set reference value. The offset correcting circuit further includes an offset calculating circuit configured to calculate the control value for correcting the offset, when it is determined that the offset has been generated with respect to the output signal value.

According to an embodiment, the temperature change checking circuit includes a temperature change determining circuit configured to calculate the current temperature variation based on the temperature data transmitted from the data transmitter, comparing the temperature variation with the pre-set reference variation, and transmit the enable signal to the charge amplifying controller, the data transmitting control circuit, and the offset detecting circuit, when the temperature variation is greater than the pre-set reference variation. According to an embodiment, the temperature change checking circuit further includes a memory configured to store initial reference temperature data and the pre-set reference variation, and store the temperature data at the point in time as the reference temperature data, when the offset correction is completed.

According to another embodiment of the invention, there is provided a method for controlling a driving circuit of a gyro sensor. The method includes a data detecting operation of receiving, by an analog circuit, one or more driving displacement signals and one or more gyro signals related to one or more sensing axes from the gyro sensor, detecting one or more direct current (DC) gyro signal values through a demodulation process using a clock signal generated by using the one or more driving displacement signals and the one or more gyro signal, and receiving temperature data from a temperature sensor. The method further includes a digital signal converting operation of converting, by a signal converter, the one or more DC gyro signals and the temperature data into one or more digital signals. Further, the method includes an offset correcting operation of receiving, by a digital circuit, the one or more gyro signal values and the temperature data from the signal converter, and comparing an output signal value from the analog circuit based on only a pre-set reference voltage with a pre-set reference value through a predetermined control signal according to a result of a comparison between a temperature variation calculated based on the temperature data with a pre-set reference variation, to control determining whether an offset has been generated with respect to the output signal value and performing correction calculation on the offset or performing termination.

According to an embodiment, the data detecting operation includes a gyro signal value detecting operation of receiving, by an analog signal processor, the one or more driving displacement signals and the one or more gyro signals from the gyro sensor, detecting the one or more DC gyro signal values through the demodulation process using the clock signal generated by using the one or more driving displacement signals and the one or more gyro signals, and applying the pre-set reference voltage in the place of the one or more driving displacement signals and the one or more gyro signals, when the enable signal is received from the digital circuit. The data detecting operation further includes receiving, by a temperature sensor signal processor, the temperature data from the temperature sensor, and sequentially transmitting, by an analog multiplexer, the one or more gyro signal values and the temperature data to the signal converter.

According to an embodiment, the gyro signal value detecting operation includes converting, by a charge amplifier, the one or more driving displacement signals and the one or more gyro signals output from the gyro sensor into one or more voltage signals, amplifying the one or more voltage signals, and outputting the same, and shifting, by a phase shifter, a phase of a first driving displacement signal among the one or more driving displacement signals by 90°. The gyro signal value detecting operation further includes generating, by a clock generator, the clock signal through a comparator by using a signal output from the phase shifter and a pre-set reference voltage; performing, by a demodulator, the demodulation process of mixing the one or more gyro signals and the clock signal, and canceling, by a filter, noise of a high frequency component from a signal input from the demodulator and outputting the one or more DC gyro signal values. Further, the gyro signal value detecting operation includes generating, by a driver, a pulse wave driving signal by using the clock signal, and applying the driving signal to the gyro sensor, and interrupting, by a charge amplifying controller, the one or more driving displacement signals and the one or more gyro signals input to the charge amplifier through the enable signal transmitted from the digital circuit and applying the pre-set reference voltage to the charge amplifier.

According to an embodiment, the offset correcting operation includes a data input operation of sequentially receiving, by a data transmitter, the one or more gyro signal values regarding each sensing axis of the gyro sensor and the temperature data from the signal converter. Further, the offset correction operation includes an offset correction calculating operation of comparing, by an offset corrector, the output signal value from the analog circuit based on only the pre-set reference voltage with the pre-set reference value through the predetermined control signal according to a result of a comparison between the temperature variation calculated based on the temperature data with the pre-set reference variation, to control determining whether the offset has been generated with respect to the output signal value and performing correction calculation on the offset or performing termination. The offset correction operation further includes performing, by a data corrector, correction on the one or more gyro signal values by using the control value input from the offset corrector.

According to an embodiment, the offset correction calculating operation includes a control signal transmitting operation of comparing, by a temperature change checking circuit, the temperature variation calculated based on the temperature data with the pre-set reference variation, transmitting the enable signal to the charge amplifying controller, when the temperature variation is greater than the pre-set reference variation. The offset correction calculating operation further includes an output signal control operation of controlling, by a data transmitting control circuit, maintaining and outputting the one or more gyro signal values prior to input of the output signal value of the analog circuit based on the pre-set reference voltage from the data transmitter, while the operation of determining whether the offset has been generated and calculating the control value for correcting the offset is being performed. Further, the offset correction calculating operation includes a calculating operation of comparing, by an offset correcting circuit, the output signal value from the analog circuit based on the pre-set reference voltage with the pre-set reference value, and determining whether the offset has been generated with respect to the one or more gyro signal values and calculating the control value for correcting the offset.

According to an embodiment, the calculating operation includes receiving, by an offset detecting circuit, the enable signal from the temperature change checking circuit, when the temperature variation calculated based on the temperature data is greater than the pre-set reference variation, and determining whether the offset has been generated with respect to the one or more gyro signal values by comparing the output signal value from the analog circuit based on the pre-set reference voltage with the pre-set reference value. The calculating operation further includes, when it is determined that the offset has been generated with respect to the one or more gyro signal values, calculating, by an offset calculating circuit, the control value for correcting the offset.

According to an embodiment, the control signal transmitting operation includes calculating, by a temperature change determining circuit, the current temperature variation based on the temperature data transmitted from the data transmitter, comparing the temperature variation with the pre-set reference variation, and transmitting the enable signal to the charge amplifying controller, the data transmitting control circuit, and the offset detecting circuit, when the temperature variation is greater than the pre-set reference variation. The control signal transmitting operation further includes storing, by a memory, initial reference temperature data and the pre-set reference variation, and storing the temperature data at the point in time as the reference temperature data, when the offset correction is completed.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a view illustrating an angular velocity detection principle of a gyro sensor according to an embodiment of the invention.

FIG. 2 is a block diagram illustrating a driving circuit of a gyro sensor according to an embodiment of the invention.

FIG. 3 is a view illustrating an overall system with respect to a driving circuit of the gyro sensor according to an embodiment of the invention.

FIG. 4 is a flow chart illustrating a control method of the gyro sensor with respect to a driving circuit according to an embodiment of the invention.

FIG. 5 is a view illustrating a process of processing a gym signal in an analog circuit according to an embodiment of the invention.

FIG. 6 is a view illustrating a data process processing in a data transmitter according to an embodiment of the invention.

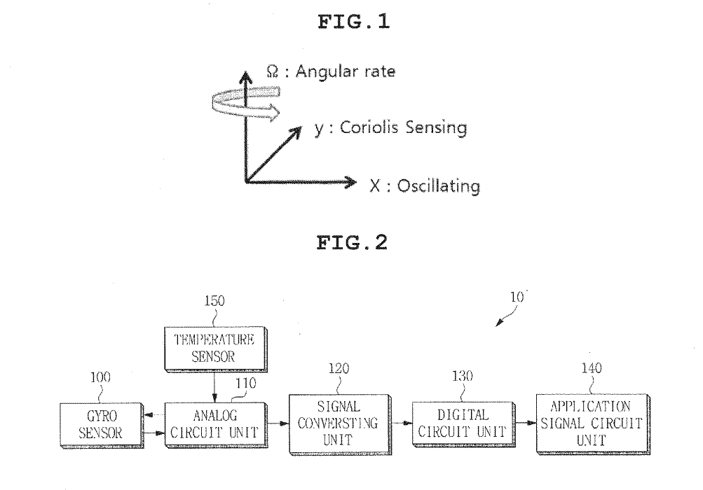

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, preferred embodiments of the present invention will be described in detail with reference to the attached drawings. A gym signal refers to a signal based on Coriolis force generated in at least one or more sensing axes (e.g., X axis, Y axis, and Z axis) of a gyro sensor, and may include first and second gyro signals having 180° phase difference.

FIG. 2 is a block diagram illustrating a driving circuit of a gyro sensor according to an embodiment of the invention. A driving circuit 10 of the gyro sensor, according to at least one embodiment, includes an analog circuit 110 receiving one or more driving displacement signals and one or more gyro signals from a gyro sensor 100, a signal converter 120 converting an output signal from the analog circuit 110 into a digital signal, a digital circuit 130 determining whether an offset has been generated with respect to an output signal from the signal converter 120 and correcting the offset in real time, and a temperature sensor 150 sensing an ambient temperature to provide temperature data T_{d}, and an application signal processor 140 performing an additional function by using an output signal from the digital circuit 130.

According to an embodiment, the gyro sensor 100 detects an angular velocity in three-axis directions positioned in space by including driving mass (not shown), and a driving signal (pulse wave) applied from the analog circuit 110 vibrates the driving mass (not shown). One or more driving displacement signals (sine wave) is generated according to the vibration. The one or more driving displacement signals include first and second driving displacement signals having a 180° phase difference.

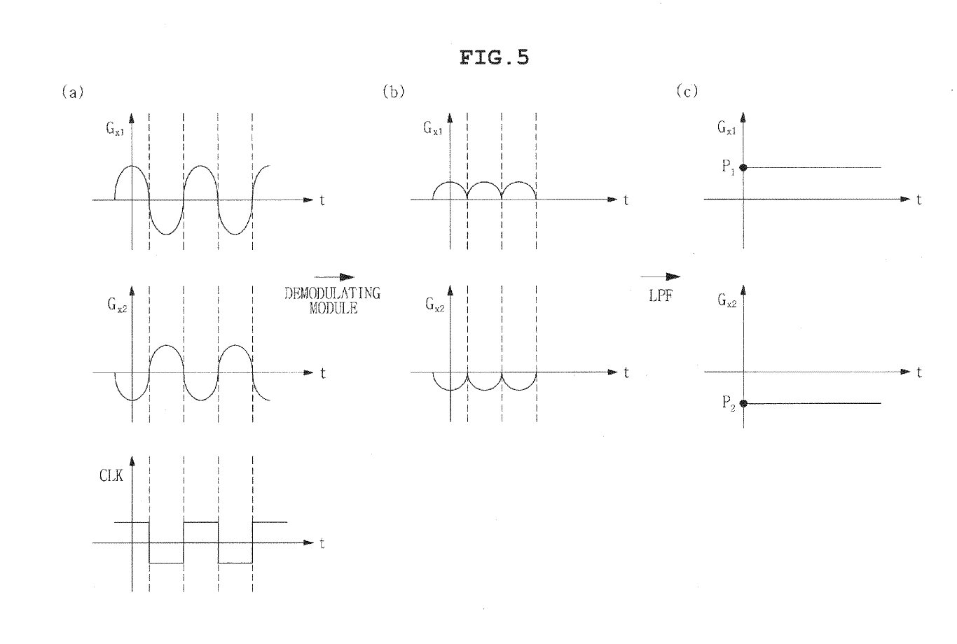

According to an embodiment, the analog circuit 110 receives the one or more driving displacement signals and the one or more gyro signals related to one or more sensing axes from the gyro sensor 100, detects one or more gyro signal values (e.g., P₁ and P₂, see FIG. 5) in a direct current (DC) through a demodulation process, and receives the temperature data T_{d} with respect to an ambient temperature from the temperature sensor 150. The analog circuit 110 includes an analog signal processor 111, a temperature sensor signal processor 112 using a clock signal CLK generated by using the one or more driving displacement signals and the one or more gyro signals, and an analog multiplexer 113. The temperature sensor 150 is provided within or outside of the analog circuit 110. Details thereof will be described herein below.

According to an embodiment, the signal converter 120 converts the one or more gyro signal values (e.g., P₁ and P₂, see FIG. 5) detected by the analog circuit 110 into one or more digital values (16 bits). Here, the signal converter 120 is, for example, an analog-to-digital converter (ADC).

According to an embodiment, the digital circuit 130 receives the one or more gyro signal values and the temperature data (T_{d}) from the signal converter 120, compares an output signal value OUT_{CM} from the analog circuit 110 based on a pre-set reference voltage V_{CM} with a pre-set reference value according to a result of a comparison between a temperature variation ΔT calculated based on the temperature data T_{d} and a pre-set reference variation, and determines whether the offset has been generated with respect to the output signal value OUT_{CM} and corrects the offset in real time. The digital circuit 130 includes a data transmitter 131, an offset corrector 135, and a data corrector 136. Here, the output signal value OUT_{CM} refers to an output value of the driving circuit 10 of the gyro sensor 100 based on the pre-set reference voltage V_{CM}, and the pre-set reference voltage V_{CM} is, for example, a DC 0.9V. Details thereof will be described herein below.

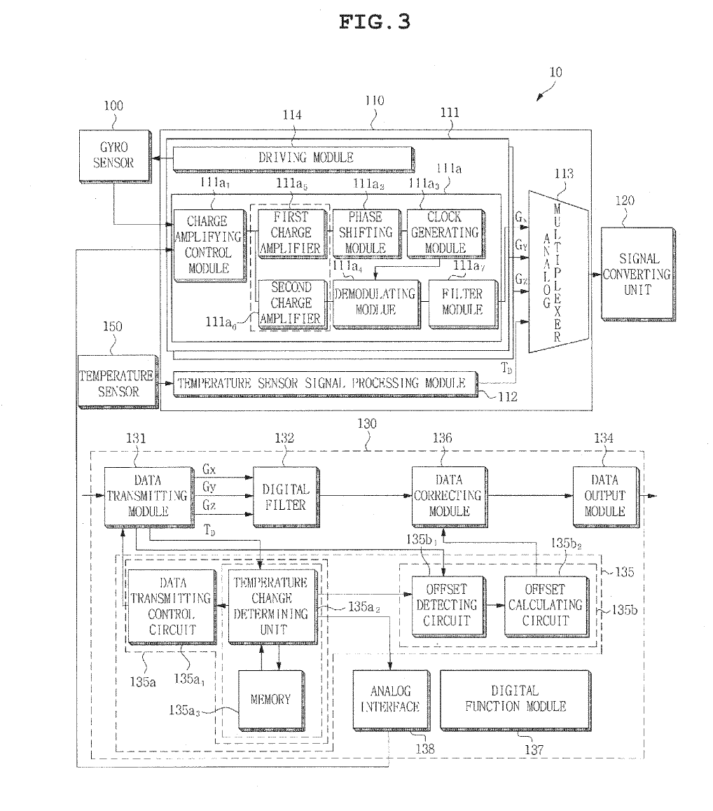

Hereinafter, driving schemes of the analog circuit 110 and the digital circuit 130, and a scheme of determining whether the offset has been generated with respect to the output signal value and correcting the offset will be described in detail with reference to FIGS. 3 through 6.

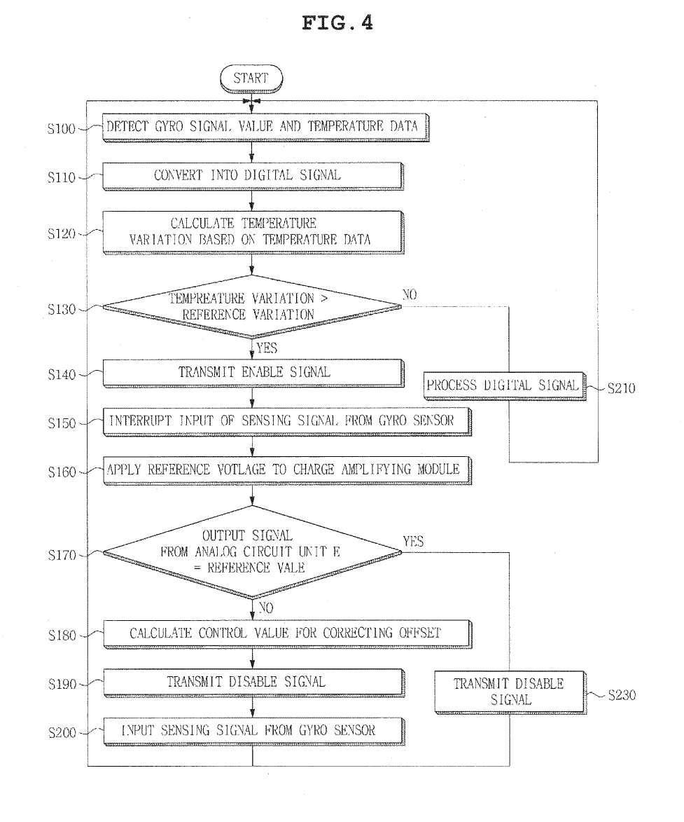

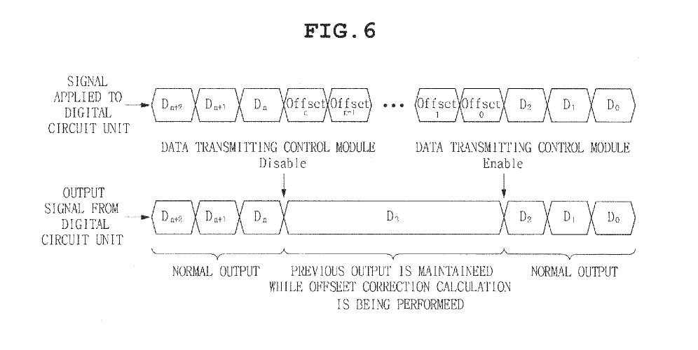

FIG. 3 is a view illustrating an overall system with respect to a driving circuit of the gyro sensor according to an embodiment of the invention, FIG. 4 is a flow chart illustrating a control method of the gyro sensor with respect to a driving circuit according to an embodiment of the invention, FIG. 5 is a view illustrating a process of processing a gyro signal in an analog circuit 110 according to an embodiment of the invention, FIG. 6 is a view illustrating a data process processing in a data transmitter according to an embodiment of the invention.

According to an embodiment, the analog circuit 110 includes the analog signal processor 111, the temperature sensor signal processor 112, and the analog multiplexer 113. The temperature sensor signal processor 112 converts ambient temperature information sensed by the temperature sensor 150 into the analog temperature data T_{d}. The analog multiplexer 113 sequentially transmits the one or more gyro signal values (e.g., P₁ and P₂) output from the analog signal processor 111 and the temperature data T_{d} output from the temperature sensor signal processor 112 to the signal converter 120 (S100). The signal converter 120 converts the temperature data T_{d} into a digital form (S110).

According to an embodiment, the analog signal processor 111 receives the one or more driving displacement signals and the one or more gyro signals from the gyro sensor 100, detects the one or more CLK gyro signal values (e.g., P₁ and P₂) through the demodulation process using the clock signal CLK generated by using the one or more driving displacement signals and the one or more gyro signals, and when the enable signal is received, the analog signal processor 111 applies the pre-set reference voltage V_{CM}, in the place of the one or more driving displacement signals and the one or more gyro signals. The analog signal processor 111 includes charge amplifiers 111a₅ and 111a₆, phase shifter 111a₂, a clock generator 111a₃, a demodulator 111a₄, a filter 111a₇, a driver 114, and a charge amplifying controller 111a₁.

Here, the analog signal processor 111 is provided in each sensing axis (e.g., X axis, Y axis, and Z axis) of the gyro sensor 100, and a gyro signal processing process of the sensing axes X axis, Y axis, and Z axis is the same, and thus, hereinafter, gyro signals G_{X1} and G_{X2} of one sensing axis (X axis) will be described.

According to an embodiment, the charge amplifiers 111a₅ and 111a₆ include a first charge amplifier 111a₅ and a second charge amplifier 111a₆ converting the one or more driving displacement signal and the one or more gyro signals output from the gyro sensor 100 into the one or more voltage signals, amplifying the one or more voltage signals, and outputting the one or more amplified voltage signals. The phase shifter 111a₂ shifts a phase of the first driving displacement signal among the driving displacement signals by 90°.

In the clock generator 111a₃, a signal output from the phase shifter 111a₂ and the pre-set reference voltage are respectively input to non-inverting terminal (+) and an inverting terminal (−) of a comparator, and the clock generator 111a₃ compares the signals to generate a clock signal CLK (see FIG. 5).

According to an embodiment, the demodulator 111a₄ performs the demodulation process of mixing the gyro signals G_{X1} and G_{X12} and the clock signal CLK (see FIG. 5) (FIG. 5(a)) to output demodulated gyro signals (FIG. 5(b)), and the filter 111a₇ cancels noise of a high frequency component from the demodulated gyro signals and outputs the one or more DC gyro signals P₁ and P₂ (see FIG. 5(c)).

According to an embodiment, the driver 114 generates a driving signal in a pulse wave form by using the clock signal, and applies the driving signal to the gyro sensor 100 to resonate the driving mass.

When the temperature variation ΔT is greater than the pre-set reference variation, the charge amplifying controller 111a₁ interrupts the one or more driving displacement signals and the one or more gyro signals input to the charge amplifiers 111a₅ and 111a₆ through the enable signal transmitted from the digital circuit 130 (S150), and applies the pre-set reference voltage V_{CM} to the charge amplifiers 111a₅ and 111a₆ (S160).

According to an embodiment, the digital circuit 130 performs digital processing on an output signal from the signal converter 120. The digital circuit 130 includes a data transmitter 131, an offset corrector 135, a data corrector 136, a digital 132, and analog interface 138.

According to an embodiment, the data transmitter 131 sequentially receives the one or more gyro signal values regarding each sensing axis of the gyro sensor 100 and the temperature data from the signal converter 120 and transmits the same to the data corrector 136.

According to the result of the comparison between the temperature variation ΔT calculated based on the temperature data and the pre-set reference variation, the offset corrector 135 compares the output signal value from the analog circuit 110 based on the pre-set reference voltage with the pre-set reference value to determine whether an offset has been generated with respect to the output signal value and calculate a control value for correcting the offset value. The offset corrector 135 includes an offset correcting control circuit 135a and an offset correcting circuit 135b. Here, the offset of the output signal value OUT_{CM} refers to a difference between the output signal value OUT_{CM} and the pre-set reference value.

Here, the offset correcting control circuit 135a compares the temperature variation ΔT calculated based on the temperature data T_{d} with the pre-set reference variation, and when the temperature variation ΔT is greater than the pre-set reference variation, the offset correcting control circuit 135a transmits the enable signal to the charge amplifying controller 111a₁ according to generation of the offset with respect to the output signal value OUT_{CM}, and when the calculation for correcting the offset is terminated, the offset correcting control circuit 135a transmits the disable signal to the charge amplifying controller 111a₁. The offset correcting control circuit 135a includes temperature change checking circuits 135a₂ and 135a₃ and a data transmitting control circuit 135a₁.

Namely, the temperature change checking circuits 135a₂ and 135a₃, according to an embodiment of the invention, compares the temperature variation ΔT calculated based on the temperature data Td with the pre-set reference variation, and when the temperature variation ΔT is greater than the pre-set reference variation, the temperature change checking circuits 135a₂ and 135a₃ transmit the enable signal to the charge amplifier controller 111a₁ according to whether the offset has been generated with respect to the output signal value OUT_{CM}, and in a case in which the calculation for correcting the offset is terminated, the temperature change checking circuits 135a₂ and 135a₃ transmit the disable signal to the charge amplifying controller 111a₁. The temperature change checking circuits 135a₂ and 135a₃ include a temperature change determining circuit 111a₂ and a memory 111a₃.

Here, the temperature change determining circuit 111a₂ calculates the current temperature variation ΔT based on the temperature data T_{d} transmitted from the data transmitter 131 (S120) and compares the temperature variation ΔT with the pre-set reference variation (S130). When the temperature variation ΔT is greater than the pre-set reference variation, the temperature change determining circuit 111a₂ transmits the enable signal to the charge amplifying controller 111a₁, the data transmitting control circuit 135a₁, and the offset detecting circuit 135b (S140). The memory 135a₃ stores initial reference temperature data and the pre-set reference variation, and when the offset correction is completed, the memory 135a₃ stores the temperature data T_{d} at the timing as the reference temperature data. Here, when the temperature variation ΔT is smaller than the pre-set reference variation, a digital signal processing process is performed on the gyro signal value input from the signal converter 120 (S210).

When the temperature variation ΔT is greater than the pre-set reference variation, the enable signal is applied from the temperature change checking circuits 135a₂ and 135a₃ to the data transmitting control circuit 135a₁, and until before the disable signal is transmitted after the enable signal is transmitted to the charge amplifying controller 111a₁, data with respect to the one or more gyro signal values prior to the input of the output signal value OUT_{CM} of the analog circuit 110 based on the pre-set reference voltage V_{CM} from the data transmitter 131 is controlled to be maintained and output.

Namely, as illustrated in FIG. 6, 1) before the offset correcting circuit 135 performs the offset correcting process, the one or more gyro signal values (e.g., P₁ and P₂) output from the analog circuit 110 is digital-converted through the signal converter 120 D₀˜D₂ and subsequently input to the data transmitter 131, and while the offset correction is being performed, output signal values Offset₀˜Offsetₙ based on the pre-set reference voltage V_{CM} are input, so outputting of the data D₀˜Dₙ with respect to the one or more gyro signal values is broken.

Thus, 2) in order to maintain outputting of the data D₀˜D₂ with respect to the one or more gyro signal values even while the offset correction is being performed, the temperature change determining circuit 135a₂ transmits the enable signal to the data transmitting control circuit 135a₁, and the data transmitting control signal 135a₁ controls the data transmitter 131 to continuously output the data D₂ with respect to the one or more gyro signal values prior to the input of the output signal values Offset₀˜Offsetₙ based on the pre-set reference voltage V_{CM}, while the offset correction is being performed (until before the disable signal is transmitted from the temperature change determining circuit 135a₂ to the data transmitting control circuit 135a₁).

According to an embodiment, the offset correcting circuit 135 performs an operation of comparing the output signal value OUT_{CM} from the analog circuit 110 based on the pre-set reference voltage V_{CM} with the pre-set reference value to determine whether the offset has been generated with respect to the output signal value OUT_{CM} and calculates the control value for correcting the offset. The offset correcting circuit 135 includes the offset detection circuit 135b₁ and the offset calculating circuit 135b₂.

Namely, when the temperature variation ΔT calculated based on the temperature data T_{d} is greater than the pre-set reference variation, the enable signal is applied from the temperature change checking circuits 135a₂ and 135a3 to the offset detecting circuit 135b₁, and the offset detecting circuit 135b₁ determines whether the offset has been generated with respect to the output signal value OUT_{CM} by comparing the output signal value OUT_{CM} of the analog circuit 110 based on the pre-set reference voltage V_{CM} with the pre-set reference value (S170). Namely, when the output signal value OUT_{CM} is different from the pre-set reference value, the offset detecting circuit 135b₁ determine that the offset has been generated in the output signal value OUT_{CM}.

When the offset detecting circuit 135b₁ determines that the offset has been generated with respect to the output signal value OUT_{CM}, the offset calculating circuit 135b₂ performs calculation to obtain the control value (i.e., a value for making the offset ‘0’) for correcting the offset (S180), and the data corrector 136 performs correction on the one or more gyro signal values (e.g., P₁ and P₂) by using the control value input from the offset corrector 135.

Here, the control value stored in the data corrector 136 is corrected to a different value according to a change in an ambient temperature.

Namely, when the offset calculating circuit 135b₂ terminates the calculation of the control value, the temperature change determining circuit 135a₂ transmits the disable signal to the charge amplifying control circuit 111a₁ (S190). Then, inputting of the one or more gyro signals from the charge amplifiers 111a₅ and 111a₆ is resumed (S200), and the data corrector 136 applies the control value to the one or more gyro signal values (e.g., P₁ and P₂) from the analog circuit 110 to correct the offset of the driving circuit 10 itself of the gyro sensor 100 due to the current temperature.

According to an embodiment, the digital filter 132 cancels noise of the one or more gyro sensor values (e.g., P₁ and P₂) and the temperature data T_{d} output from the data transmitter 131. The analog interface 138 transmits the control signal input from the offset corrector 135 to the charge amplifying controller 111a₁. A data output controller 134 transmits the data of the one or more gyro signal values output from the data corrector 136 and a particular event occurrence signal to a host. A digital function processor 137 includes a clock generator, a timing controller, a digital signal processor, etc., required for operating the digital circuit 130.

According to various embodiments of the invention, the driving circuit of a gyro sensor detects generation of an offset in itself based on a change in an ambient temperature and calculates a control value for correcting the offset to perform offset correction on an output signal that may be generated according to a change in an operating temperature with respect to the driving circuit, in real time, thereby securing reliability in processing an output signal from the gyro sensor.

Also, even while calculation of control value for offset correction with respect to an output signal of the driving circuit is being performed, an output signal value of the gyro sensor prior to performing the offset correction is continuously output through controlling by the offset correcting module with respect to the data transmitting module, thereby securing continuity of the output signal value of the gyro sensor even during the offset correcting process by the offset correcting module.

In addition, by performing correction on an offset that may be generated due to a change in an ambient temperature with respect to the entire driving circuit of the gyro sensor in real time, an error due to characteristics deviation of individual elements constituting the driving circuit does not need to be considered, and thus, error correction with respect to a gyro signal value that may be generated due to a change in an ambient temperature may be simplified and accuracy of the signal value may be secured.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a.” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A driving circuit of a gyro sensor, the driving circuit comprising:
an analog circuit configured to
receive one or more driving displacement signals and one or more gyro signals related to one or more sensing axes from the gyro sensor,
detect one or more direct current (DC) gyro signal values through a demodulation process using a clock signal generated by using the one or more driving displacement signals and the one or more gyro signals, and
receive temperature data from a temperature sensor;
a signal converter configured to convert the one or more DC gyro signals and the temperature data into one or more digital signals; and
a digital circuit configured to
receive the one or more DC gyro signal values and the temperature data from the signal converter, and
compare an output signal value from the analog circuit based on only a pre-set reference voltage with a pre-set reference value through a predetermined control signal according to a result of a comparison between a temperature variation calculated based on the temperature data with a pre-set reference variation, to control a determination of whether an offset has been generated with respect to the output signal value and performing a correction calculation on the offset or performing a termination.

2. The driving circuit as set forth in claim 1, wherein, when the temperature variation is greater than the pre-set reference variation, the digital circuit is further configured to
interrupt inputting of the one or more driving displacement signals and the one or more gyro signals,
transmit an enable signal for applying only the pre-set reference voltage to the analog circuit, to the analog circuit,
compare the output signal value from the analog circuit based on the pre-set reference voltage with the pre-set reference value to determine generation of the offset with respect to the output signal value and perform calculation to correct the offset, and when the calculation of the offset correction is terminated, the digital circuit is further configured to transmit a disable signal for inputting the one or more driving displacement signals and the one or more gyro signals, to the analog circuit.

3. The driving circuit as set forth in claim 2, wherein the analog circuit comprises:
an analog signal processor configured to
receive the one or more driving displacement signals and the one or more gyro signals,
detect the one or more DC gyro signal values through a demodulation process using a clock signal generated by using the one or more driving displacement signals and the one or more gyro signals from the gyro sensor, and
apply the pre-set reference voltage in the place of the one or more driving displacement signals and the one or more gyro signals, when the enable signal is received;
a temperature sensor signal processor configured to receive the temperature data from the temperature sensor; and
an analog multiplexer configured to sequentially transmit the one or more gyro signal values and the temperature data to the signal converter.

4. The driving circuit as set forth in claim 3, wherein the analog signal processor comprises:
a charge amplifier configured to convert the one or more driving displacement signals and the one or more gyro signals output from the gyro sensor into voltage signals, amplify the voltage signals, and output the same;
a phase shifter configured to shift a phase of a first driving displacement signal among the one or more driving displacement signals by 90°;
a clock generator configured to generate the clock signal through a comparator by using a signal output from the phase shifter and a pre-set reference voltage;
a demodulator configured to perform a demodulation process of mixing the one or more gyro signals and the clock signal;
a filter configured to cancel noise of a high frequency component from a signal input from the demodulator and output the one or more DC gyro signal values;
a signal driver configured to generate a pulse wave driving signal by using the clock signal, and apply the driving signal to the gyro sensor; and
a charge amplifying controller configured to interrupt the one or more driving displacement signals and the one or more gyro signals input to the charge amplifier through the enable signal transmitted from the digital circuit and apply the pre-set reference voltage to the charge amplifier, when the temperature variation is greater than the pre-set reference variation.

5. The driving circuit as set forth in claim 4, wherein the digital circuit comprises:
a data transmitter configured to sequentially receive the one or more gyro signal values regarding each sensing axis of the gyro sensor and the temperature data from the signal converter;
an offset corrector configured to compare an output signal value from the analog circuit based on only a pre-set reference voltage with a pre-set reference value through a predetermined control signal according to a result of a comparison between the temperature variation calculated based on the temperature data with the pre-set reference variation, to control determining whether the offset has been generated with respect to the output signal value and performing correction calculation on the offset or performing termination; and
a data corrector configured to perform correction on the one or more gyro signal values by using the control value input from the offset corrector.

6. The driving circuit as set forth in claim 5, wherein the digital circuit further comprises:
a digital filter configured to cancel noise of the one or more gyro signal values and the temperature data output from the data transmitter; and
an analog interface configured to transmit the control signal output from the offset corrector into the charge amplifying controller.

7. The driving circuit as set forth in claim 5, wherein the offset corrector comprises:
an offset correcting control circuit configured to
compare the temperature variation calculated based on the temperature data with the pre-set reference variation,
transmit the enable signal to the charge amplifying controller according to generation of the offset with respect to the output signal value, when the temperature variation is greater than the pre-set reference variation, and
transmit the disable signal to the charge amplifier, when the calculation for the offset correction is terminated; and
an offset corrector configured to
compare the output signal value from the analog circuit based on a reference signal with the pre-set reference value, and
determine whether the offset has been generated with respect to the one or more gyro signal values and calculate a control value for correcting the offset.

8. The driving circuit as set forth in claim 7, wherein, until before the disable signal is transmitted after the enable signal is transmitted to the charge amplifying controller, the offset correcting control circuit is further configured to control maintaining and outputting the one or more gyro signal values prior to input of the output signal value of the analog circuit based on the pre-set reference voltage from the data transmitter.

9. The driving circuit as set forth in claim 8, wherein the offset correcting control circuit comprises:
a temperature change checking circuit configured to
compare the temperature variation calculated based on the temperature data with the pre-set reference variation,
transmit the enable signal to the charge amplifying controller according to the generation of the offset with respect to the output signal value, when the temperature variation is greater than the pre-set reference variation, and
transmit the disable signal to the charge amplifier, when the calculation for correcting the offset is terminated; and
a data transmitting control circuit configured to
receive the enable signal applied from the temperature change checking circuit, when the temperature variation is greater than the pre-set reference variation, and
control maintaining and outputting the one or more gyro signal values prior to the input of the output signal value of the analog circuit based on the pre-set reference voltage from the data transmitter until before the disable signal is transmitted after the enable signal is transmitted to the charge amplifying controller.

10. The driving circuit as set forth in claim 9, wherein the offset correcting circuit comprises:
an offset detecting circuit configured to
receive the enable signal from the temperature change checking circuit, when the temperature variation calculated based on the temperature data is greater than the pre-set reference variation, and
determine whether the offset has been generated with respect to the output signal value by comparing an output signal value from the analog circuit based on the pre-set reference voltage with the pre-set reference value; and
an offset calculating circuit configured to calculate the control value for correcting the offset, when it is determined that the offset has been generated with respect to the output signal value.

11. The driving as set forth in claim 9, wherein the temperature change checking circuit comprises:
a temperature change determining circuit configured to
calculate the current temperature variation based on the temperature data transmitted from the data transmitter, comparing the temperature variation with the pre-set reference variation, and
transmit the enable signal to the charge amplifying controller, the data transmitting control circuit, and the offset detecting circuit, when the temperature variation is greater than the pre-set reference variation; and
a memory configured to store initial reference temperature data and the pre-set reference variation, and store the temperature data at the point in time as the reference temperature data, when the offset correction is completed.

12. A method for controlling a driving circuit of a gyro sensor, the method comprising:
a data detecting operation of receiving, by an analog circuit, one or more driving displacement signals and one or more gyro signals related to one or more sensing axes from the gyro sensor, detecting one or more direct current (DC) gyro signal values through a demodulation process using a clock signal generated by using the one or more driving displacement signals and the one or more gyro signal, and receiving temperature data from a temperature sensor;
a digital signal converting operation of converting, by a signal converter, the one or more DC gyro signals and the temperature data into one or more digital signals; and
an offset correcting operation of receiving, by a digital circuit, the one or more gyro signal values and the temperature data from the signal converter, and comparing an output signal value from the analog circuit based on only a pre-set reference voltage with a pre-set reference value through a predetermined control signal according to a result of a comparison between a temperature variation calculated based on the temperature data with a pre-set reference variation, to control determining whether an offset has been generated with respect to the output signal value and performing correction calculation on the offset or performing termination.

13. The method as set forth in claim 12, wherein the data detecting operation comprises:
a gyro signal value detecting operation of receiving, by an analog signal processor, the one or more driving displacement signals and the one or more gyro signals from the gyro sensor, detecting the one or more DC gyro signal values through the demodulation process using the clock signal generated by using the one or more driving displacement signals and the one or more gyro signals, and applying the pre-set reference voltage in the place of the one or more driving displacement signals and the one or more gyro signals, when the enable signal is received from the digital circuit;
receiving, by a temperature sensor signal processor, the temperature data from the temperature sensor, and
sequentially transmitting, by an analog multiplexer, the one or more gyro signal values and the temperature data to the signal converter.

14. The method as set forth in claim 13, wherein the gyro signal value detecting operation comprises:
converting, by a charge amplifier, the one or more driving displacement signals and the one or more gyro signals output from the gyro sensor into one or more voltage signals, amplifying the one or more voltage signals, and outputting the same;
shifting, by a phase shifter, a phase of a first driving displacement signal among the one or more driving displacement signals by 90°;
generating, by a clock generator, the clock signal through a comparator by using a signal output from the phase shifter and a pre-set reference voltage;
performing, by a demodulator, the demodulation process of mixing the one or more gyro signals and the clock signal;
canceling, by a filter, noise of a high frequency component from a signal input from the demodulator and outputting the one or more DC gyro signal values;
generating, by a driver, a pulse wave driving signal by using the clock signal, and applying the driving signal to the gyro sensor; and
interrupting, by a charge amplifying controller, the one or more driving displacement signals and the one or more gyro signals input to the charge amplifier through the enable signal transmitted from the digital circuit and applying the pre-set reference voltage to the charge amplifier.

15. The method as set forth in claim 14, wherein the offset correcting operation comprises:
a data input operation of sequentially receiving, by a data transmitter, the one or more gyro signal values regarding each sensing axis of the gyro sensor and the temperature data from the signal converter;
an offset correction calculating operation of comparing, by an offset corrector, the output signal value from the analog circuit based on only the pre-set reference voltage with the pre-set reference value through the predetermined control signal according to a result of a comparison between the temperature variation calculated based on the temperature data with the pre-set reference variation, to control determining whether the offset has been generated with respect to the output signal value and performing correction calculation on the offset or performing termination; and
performing, by a data corrector, correction on the one or more gyro signal values by using the control value input from the offset corrector.

16. The method as set forth in claim 15, wherein the offset correction calculating operation comprises:
a control signal transmitting operation of comparing, by a temperature change checking circuit, the temperature variation calculated based on the temperature data with the pre-set reference variation, transmitting the enable signal to the charge amplifying controller, when the temperature variation is greater than the pre-set reference variation;
an output signal control operation of controlling, by a data transmitting control circuit, maintaining and outputting the one or more gyro signal values prior to input of the output signal value of the analog circuit based on the pre-set reference voltage from the data transmitter, while the operation of determining whether the offset has been generated and calculating the control value for correcting the offset is being performed; and
a calculating operation of comparing, by an offset correcting circuit, the output signal value from the analog circuit based on the pre-set reference voltage with the pre-set reference value, and determining whether the offset has been generated with respect to the one or more gyro signal values and calculating the control value for correcting the offset.

17. The method as set forth in claim 16, wherein the calculating operation comprises:
receiving, by an offset detecting circuit, the enable signal from the temperature change checking circuit, when the temperature variation calculated based on the temperature data is greater than the pre-set reference variation, and determining whether the offset has been generated with respect to the one or more gyro signal values by comparing the output signal value from the analog circuit based on the pre-set reference voltage with the pre-set reference value; and
when it is determined that the offset has been generated with respect to the one or more gyro signal values, calculating, by an offset calculating circuit, the control value for correcting the offset.

18. The method as set forth in claim 16, wherein the control signal transmitting operation comprises:
calculating, by a temperature change determining circuit, the current temperature variation based on the temperature data transmitted from the data transmitter, comparing the temperature variation with the pre-set reference variation, and transmitting the enable signal to the charge amplifying controller, the data transmitting control circuit, and the offset detecting circuit, when the temperature variation is greater than the pre-set reference variation; and
storing, by a memory, initial reference temperature data and the pre-set reference variation, and storing the temperature data at the point in time as the reference temperature data, when the offset correction is completed.
